(19) United States
(12) Patent Application Publication
(10) Pub. No.: US 2007/0152739 A1
(43) Pub. Date: Jul. 5, 2007

(54) POWER MANAGEMENT IN INTEGRATED CIRCUITS USING PROCESS DETECTION

(75) Inventors: Jaideep Banerjee, Haryana (IN); Tushar S. Nandurkar, Jabalpur (IN)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc., Austin, TX (US)

(21) Appl. No.: 11/617,770

(22) Filed: Dec. 29, 2006

(30) Foreign Application Priority Data
Jan. 3, 2006 (IN) 30/DEL/2006

(51) Int. Cl. G05F 1/10

(52) U.S. Cl. 327/538

(57) ABSTRACT

A power management system for managing power in an integrated circuit includes a controller and a voltage generator. The controller generates a control signal based on one or more process corners of the integrated circuit. The voltage generator generates a supply voltage based on the control signal, and provides the supply voltage to the integrated circuit to manage the power within the integrated circuit.

### BACKGROUND OF THE INVENTION

The present invention relates generally to the field of integrated circuits (ICs) and in particular, to power management in ICs.

ICs show a wide variation in power consumption and performance with a change in process corners and operating temperature. As used herein, the term “process corner” refers to both variation in fabrication process as well as change in operating temperature. For example, run time currents in an IC vary with the change in the process corners. At a worst case (wcs) process corner, the speed of operation of the IC is the slowest. However, the run time currents and hence the power consumption in the IC is lower than at typical case (typ) or best case (bcs) process corners. Since digital circuits in the IC usually are designed for the worst case process corner, the supply voltage provided to the IC compensates to meet desired frequency of operation at the worst case process corner, which is higher than necessary in typical and best case process corners for the same frequency of operation. This results in unwanted power consumption when the IC operates at the same supply voltage for typical and best case (bcs) process corners as well. Use of higher than necessary voltage also makes the circuit too fast in bcs process corner, which may lead to timing violations like, ‘hold time violations’ in sequential circuits. This increases the time required for design closure and ultimately chip tape-out, since the time delays have to be verified at the different process corners before the design can tape-out.

Process corner and temperature detect circuits (herein process detect circuits) are commonly used in modern ICs, particularly in load adaptive pad drivers, which drive an output pad of the IC. In this case, a slope of a reference signal is generated based on the process corner of the IC. The slope is compared with an output signal of the IC. If the transitions in the output signal are found to be slower than for the slope, the output signal is adjusted to compensate for such slower transitions using the load adaptive pad driver circuit. The driver then maintains the output signal at a constant speed at the output pad, irrespective of the load connected to the output pad. Therefore, a constant slew rate is maintained in the output signal.

Some other uses of process detect circuits are in critical analog circuits like reference current or voltage generators. The technique mentioned above is used to make circuit performance independent of process corners, hence improve IC production yield. However, process detect circuits, on their own, do not provide for control of run time currents.

### BRIEF DESCRIPTION OF THE DRAWINGS

The following detailed description of preferred embodiments of the present invention will be better understood when read in conjunction with the appended drawings. The present invention is illustrated by way of example and not limited by the accompanying figures, in which like references indicate similar elements.

FIG. 1 is a schematic block diagram of a power management system in an integrated circuit, in accordance with an embodiment of the present invention;

FIG. 2 is a schematic block diagram of a controller in accordance with an embodiment of the present invention;

FIG. 3 is a schematic block diagram of a control signal generator in accordance with an embodiment of the present invention;

FIG. 4 is a schematic block diagram of a voltage generator in accordance with an embodiment of the present invention;

FIG. 5 is a schematic block diagram of a voltage generator in accordance with another embodiment of the present invention;

FIG. 6 is a schematic block diagram of an electronic device in accordance with an embodiment of the present invention; and

FIG. 7 is a flowchart depicting a method for managing power in an integrated circuit in accordance with an embodiment of the present invention.

### DETAILED DESCRIPTION OF THE PRESENT INVENTION

The detailed description in connection with the appended drawings is intended as a description of the presently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

The present invention provides a power management system for managing power in an integrated circuit (IC). The power management system includes a controller and a voltage generator. The controller detects a process corner of the IC and generates a control signal. The voltage generator is coupled to the controller. The voltage generator receives the control signal and generates a supply voltage based on the control signal to the IC.

In another embodiment of the present invention, the present invention provides an electronic device that includes at least a first integrated circuit (IC) and a second IC. The first IC includes a plurality of functional units. The electronic device includes a controller in the first IC and a voltage generator in the second IC. The controller generates a control signal based on the process corners of the first IC. The voltage generator is coupled to the controller. The voltage generator provides a supply voltage based on the control signal to one or more of the functional units of the first IC.

In another embodiment of the present invention, the present invention provides a method for managing power in an integrated circuit (IC). The IC includes a plurality of functional units. The method includes generating a control signal based on the process corners of the IC, and providing a supply voltage based on the control signal to one or more of the functional units.

Embodiments of the present invention provide a power management system, which can be implemented on a small area in one or more integrated circuits. The power management system is suitable for detecting process corners at which an IC is fabricated. The power management system manages power for variations in the process corners in real-time. In one case, this is accomplished by detecting a process corner of the IC in real-time and varying a supply voltage to the IC accordingly. In another case, the power management system is implemented in two different ICs. In this implementation, the process corner variations are detected in a first IC, and the supply voltage that varies according to the process corner variations is provided to the first IC by a second IC. Further, the power management system can be fabricated using any standard technology, such as complementary metal oxide semiconductor (CMOS) technology and bipolar complementary metal oxide semiconductor (BiCMOS) technology.

Referring now to FIG. 1, a schematic block diagram of a power management system 102 in an IC in accordance with an embodiment of the present invention is shown. The IC includes the power management system 102 and multiple functional units (not shown in FIG. 1). The power management system 102 includes a controller 104 and a voltage generator 106. The power management system 102 manages power in the IC by providing a supply voltage that varies according to the process corner variations to the IC. More particularly, the controller 104 generates a control signal based on the process corner. The voltage generator 106 is coupled to the controller 104. The voltage generator 106 generates the supply voltage based on the control signal. The supply voltage can be provided to all the functional units of the IC, or selectively to one or more of the functional units.

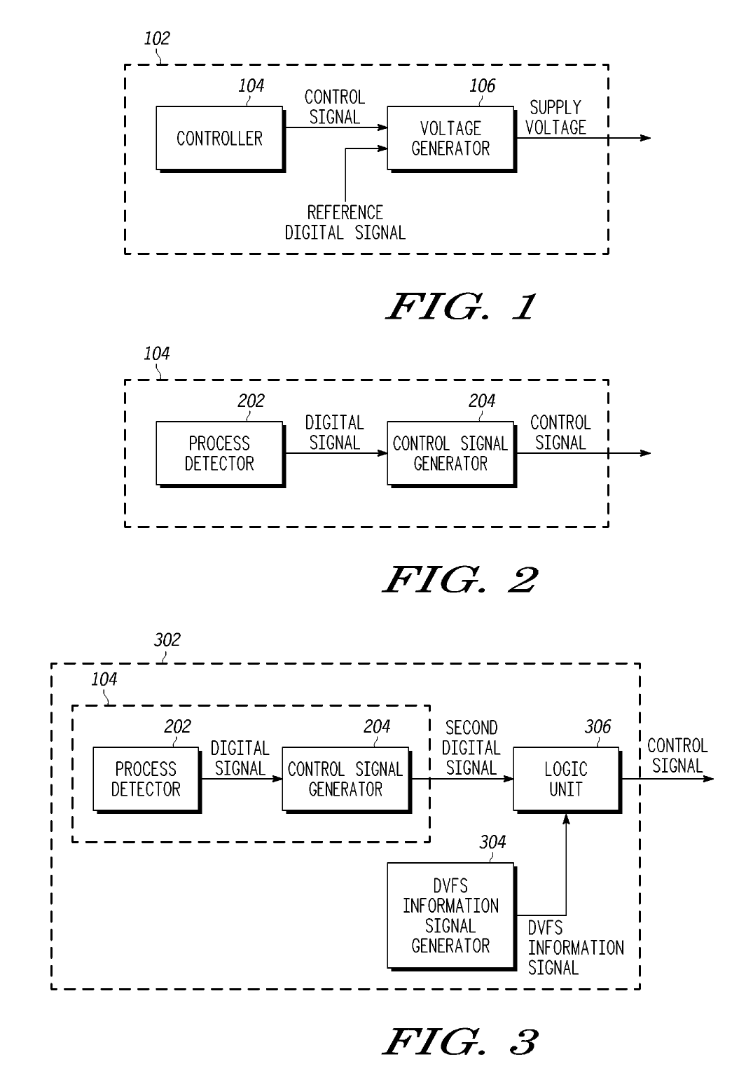

FIG. 2 is a schematic block diagram of the controller 104 in accordance with an embodiment of the present invention. The controller 104 includes a process detector 202 and a control signal generator 204. The control signal generator 204 is coupled to the process detector 202. The process detector 202 detects process corners of the IC and generates a digital signal. The digital signal varies in accordance with the changes in the process corners of the IC. The control signal generator 204 receives the digital signal and generates the control signal based on the digital signal.

In an exemplary embodiment of the present invention, the process detector 202 is a ring oscillator that generates the digital signal. For example, a ring oscillator operating at a best case process corner of the IC generates the digital signal with higher frequency than a ring oscillator operating at a worst case process corner.

In one embodiment of the present invention, the control signal generator 204 includes a counter. The counter receives the digital signal from the process detector 202 and a reference digital signal as inputs, and generates the control signal as an output. In one example, a frequency of the reference digital signal is around 13 MHz and the frequency of the digital signal is around 400 MHz. The counter generates the control signal by counting the number of pulses of the digital signal in a clock cycle of the reference digital signal.

In another embodiment of the present invention, the controller 104 is combined with a dynamic voltage and frequency scaling (DVFS) information signal generator and a logic unit. DVFS refers to a power saving technique of providing an optimal supply voltage and clock frequency to the IC that is just sufficient to perform the operations of the IC.

FIG. 3 is a schematic block diagram of a combined controller 302 in accordance with such an embodiment. The combined controller 302 includes the controller 104, a DVFS information signal generator 304, and a logic unit 306. The DVFS information signal generator 304 generates a DVFS information signal based on a set of performance metrics of the IC. Examples of the performance metrics include, but are not limited to, the supply voltage at which the IC is presently operating, and the clock frequency. The DVFS information signal includes information regarding the optimum values of the supply voltage and the clock frequency, so as to save maximum possible power while maintaining the performance of the IC. In this embodiment, the logic unit 306 is coupled to the DVFS information signal generator 304 and the controller 104. The logic unit 306 generates a control signal for a voltage generator by logically combining process corner information from the controller 104 and the DVFS information signal from the DVFS information signal generator 304. By doing so, the DVFS information and the process corner variations are taken into account in the control signal.

For example, if an IC has a functional unit that supports DVFS and supply voltages are specified at 1.2V and 1.4V, which are the supply voltages needed for low frequency and high frequency applications at a typical process corner. In this example, a single bit is output by the DVFS information signal generator 304, where ‘0’ denotes a low frequency application and hence 1.2V and ‘1’ denotes a high frequency application and hence 1.4V in the ‘typ’ process corner. If there are three process corners, ‘bcs’, ‘typ’ and ‘wcs’, then to code the three process corners two more bits are provided. For example, ‘00’ for wcs, ‘01’ for typ, and ‘10’ for ‘bcs’. Also let 1.3V supply be sufficient for functional blocks to sustain high frequency operation in ‘bcs’ process corner. In this case, the DVFS information signal generator 304 outputs ‘1’ and the process detect controller 104 outputs ‘10’. The logic unit 306 combines the DVFS information signal (‘1’) and the second digital signal “10’ from the controller 104 to generate the control signal, which programs the output of the voltage generator 106 to be 1.3V.

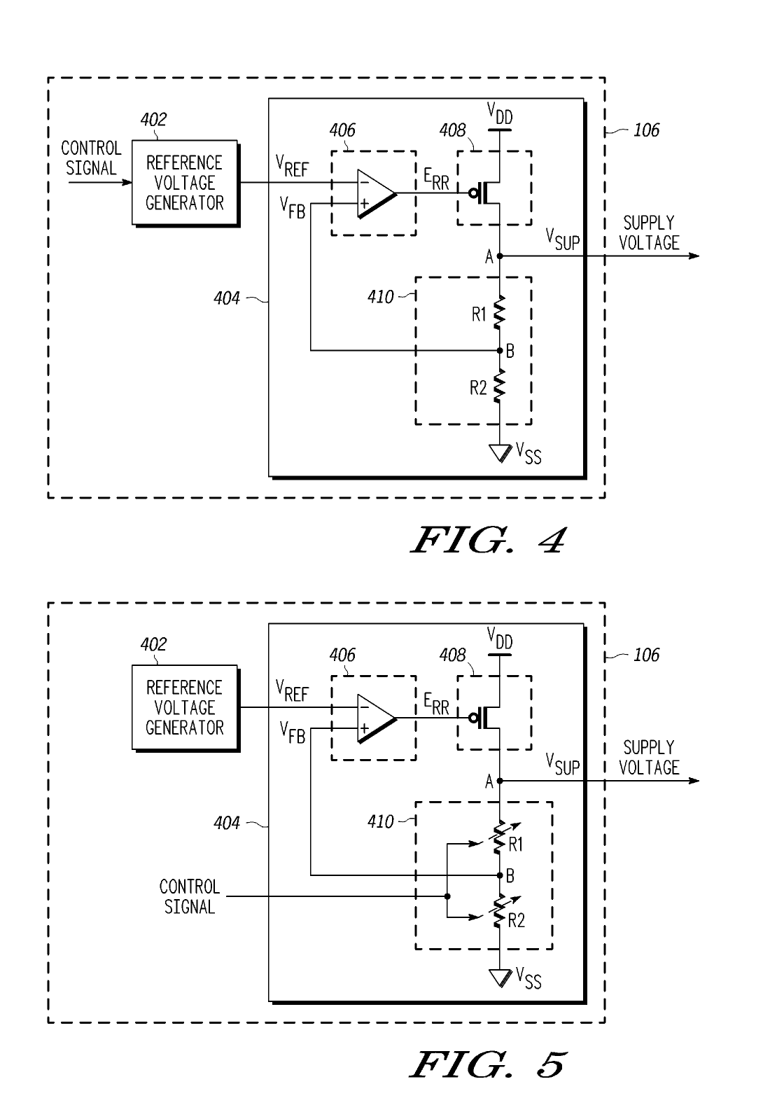

FIG. 4 is a schematic block diagram of the voltage generator 106 in accordance with an embodiment of the present invention. The voltage generator 106 includes a reference voltage generator 402 and a supply voltage generator 404. The reference voltage generator 402 receives the control signal from the controller 104 (or the controller 302), and generates a reference voltage V_{ref} based on the control signal. In other words, V_{ref} varies according to the control signal. An example of the reference voltage generator 402 includes a digital to analog converter (DAC). The DAC converts the control signal, which is in digital form to the reference voltage. The supply voltage generator 404 is coupled to the reference voltage generator 402. The supply voltage generator 404 generates the supply voltage using V_{ref}. Another way of generating V_{ref} is to use a constant voltage source to drive a chain of series resistance chain and tap required voltages from various points of the resistance chain.

The supply voltage generator 404 includes a comparator 406, a semiconductor switch 408, and a voltage divider unit 410. The supply voltage generator 404 supplies power to one or more functional units of an IC. An example of the comparator 406 is an operational amplifier. Examples of the semiconductor switch 408 include PMOS and NMOS transistor switches. In this embodiment, the semiconductor switch 408 is implemented with a PMOS transistor. The voltage divider unit 410 includes resistors R₁ and R₂ that are connected with each other at a node B. The comparator 406 receives V_{ref} as one of its two inputs. The voltage divider unit 410 supplies a feedback voltage V_{fb} at the node B as a second input to the comparator 406. The output of the comparator 406 is connected to the gate of the semiconductor switch 408. A source of the semiconductor switch 408 is connected to a voltage V_{dd} and a drain is connected to a node A. Node A is also connected to the resistor R₁. Resistor R₂ also is connected to a voltage Vₛₛ.

The comparator 406 compares the voltages V_{ref} and V_{fb}, and generates an error signal Err, which represents the difference between V_{ref} and V_{fb}. The error signal is supplied to the gate of the semiconductor switch 408. Depending on the value of the error signal Err and current drawn by functional units (not shown), the supply voltage Vₛᵤₚ is generated at the node A.

FIG. 5 is a schematic block diagram of the voltage generator 106 in accordance with another embodiment of the present invention. In this embodiment, the reference voltage generator 402 generates the reference voltage V_{ref}, which has an arbitrary value. The control signal is provided to the voltage divider unit 410 so that the resistances of the resistors R₁ and R₂ vary based on the control signal. The supply voltage Vₛᵤₚ is generated at the node A in a manner similar to that described above in conjunction with FIG. 4.

FIG. 6 is a schematic block diagram of an electronic device 600 that includes the power management system 102 in accordance with an embodiment of the present invention. In this embodiment, the power management system 102 includes the controller 104 and the voltage generator 106. The controller 104 is in a first IC 602 and the voltage generator 106 is in a second IC 604. The voltage generator 106 is coupled to the controller 104. The first IC 602 also includes a plurality of functional units 606, 608 and 610. Although three functional units are shown, the first IC 602 may have more or fewer functional units. The power management system 102 manages power in the functional units 606, 608 and 610 of the first IC 602 by providing the supply voltage Vₛᵤₚ to the functional units 606, 608 and 610. The controller 104 detects the process corner variations of the first IC 602 and generates the control signal based on the process corner variations. In an embodiment of the present invention, the control signal is based on both the detected process corner variations and DVFS information as described earlier. The voltage generator 106 generates the supply voltage Vₛᵤₚ based on the detected process corner variations of the first IC 602 as described earlier in conjunction with FIGS. 4 and 5.

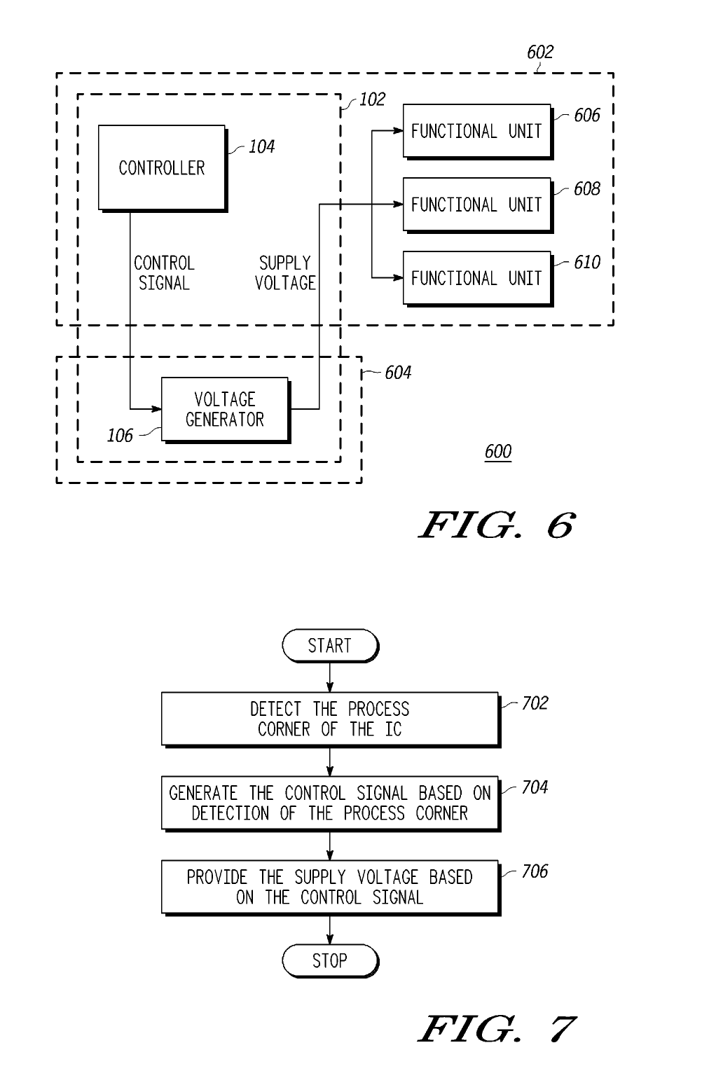

FIG. 7 is a flowchart depicting a method for managing power in the IC in accordance with an embodiment of the present invention. At step 702, the process corner at which the IC is operating is detected. The process corner is detected by the process detector 202. At step 704, the control signal is generated by the controller 104 based on the detection of the process corner. At step 706, the supply voltage based on the control signal is provided to the functional units of the IC. The supply voltage is provided by the voltage generator 106.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A power management system for managing power in an integrated circuit (IC), the power management system comprising:
a controller for generating a control signal, wherein the control signal is based on at least one process corner of the IC; and
a voltage generator, coupled to the controller, for providing to the IC a supply voltage based on the control signal.

2. The power management system of claim 1, wherein the controller comprises:
a process detector for detecting the at least one process corner, and generating a digital signal based on the detection of the at least one process corner; and
a control signal generator, coupled to the process detector, for generating the control signal using the digital signal.

3. The power management system of claim 2, wherein the process detector comprises a ring oscillator.

4. The power management system of claim 2, wherein the control signal generator comprises a counter that generates the control signal by counting a number of pulses of the digital signal in a clock cycle of a reference digital signal.

5. The power management system of claim 2, wherein the controller further comprises:
a dynamic voltage and frequency scaling (DVFS) information signal generator for generating a DVFS information signal based on a set of performance metrics of the IC; and
a logic unit, coupled to the DVFS information signal generator and the control signal generator, for modifying the control signal using the DVFS information signal.

6. The power management system of claim 1, wherein the voltage generator comprises:
a reference voltage generator for generating a reference voltage; and
a supply voltage generator, coupled to the reference voltage generator, for generating the supply voltage using the reference voltage.

7. The power management system of claim 6, wherein a value of the reference voltage is based on the control signal.

8. The power management system of claim 6, wherein the supply voltage generator comprises:
a comparator for comparing the reference voltage with a feedback voltage, and generating an error signal in response to comparing the reference voltage with the feedback voltage;
a voltage divider unit, coupled to the comparator, for providing the feedback voltage to the comparator; and
a semiconductor switch, coupled to the comparator, for providing the supply voltage in response to a value of the error signal.

9. The power management system of claim 8, wherein the voltage divider unit includes a first resistor and a second resistor, wherein resistances of the first resistor and the second resistor are controlled by the control signal.

10. An electronic device including at least a first integrated circuit (IC) and a second IC, the first IC including a plurality of functional units, the electronic device comprising:
a controller in the first IC, for generating a control signal based on at least one process corner of the first IC; and
a voltage generator in the second IC and coupled to the controller, for providing a supply voltage based on the control signal to at least one of the functional units of the first IC.

11. The electronic device of claim 10, wherein the controller comprises:
a process detector for detecting the at least one process corner, and generating a digital signal based on the detection of the at least one process corner; and
a control signal generator, coupled to the process detector, for generating the control signal using the digital signal.

12. The electronic device of claim 10, wherein the voltage generator comprises:
a reference voltage generator for generating a reference voltage; and
a supply voltage generator, coupled to the reference voltage generator, for generating the supply voltage using the reference voltage.

13. The electronic device of claim 12, wherein the supply voltage generator comprises:
a comparator for comparing the reference voltage with a feedback voltage, and generating an error signal in response to comparing the reference voltage with the reduced voltage;
a voltage divider unit, coupled to the comparator, for providing the feedback voltage to the comparator; and
a semiconductor switch, coupled to the comparator, for providing the supply voltage in response to a value of the error signal.

14. A method of managing power in an integrated circuit (IC), the IC including a plurality of functional units, the method comprising:
generating a control signal based on at least one process corner of the IC; and
providing a supply voltage based on the control signal to at least one of the functional units.

15. The method of managing power of claim 14, wherein generating the control signal comprises:
detecting the at least one process corner of the IC;
generating a digital signal based on the detection of the at least one process corner; and
generating the control signal using the digital signal.

16. The method of managing power of claim 15, wherein generating the control signal comprises counting a number of pulses of the digital signal in a clock cycle of a reference digital signal.

17. The method of managing power of claim 14, wherein generating the control signal further comprises:
generating a dynamic voltage and frequency scaling (DVFS) information signal based on a set of performance metrics of the IC; and
modifying the control signal using the DVFS information signal.

18. The method of managing power of claim 14, wherein providing the supply voltage comprises:
generating a reference voltage; and
generating a supply voltage using the reference voltage.

19. The method of managing power of claim 18, wherein generating the reference voltage comprises using the control signal to generate the reference voltage.

20. The method of managing power of claim 18, wherein generating the supply voltage comprises:
comparing the reference voltage with a feedback voltage;
generating an error signal in response to comparing the reference voltage with the feedback voltage; and generating the supply voltage based on a value of the error signal.
